(19) United States
(12) Patent Application Publication
(10) Pub. No.: US 2004/0267814 A1
(43) Pub. Date: Dec. 30, 2004

(54) Master test plan/system test plan database tool

(76) Inventors: Michael F. Ludwig, St. Peters, MO (US); William J. Jaconetti, St. Louis, MO (US); David C. Nelson, St. Charles, MO (US)

Correspondence Address: Frank J. Bozzo, BLACK LOWE & GRAHAM PLLC, 816 Second Avenue, Seattle, WA, 98104, US

(21) Appl. No.: 10/611,755

(22) Filed: Jun. 30, 2003

(51) Int. Cl. G06F 7/00

(52) U.S. Cl. 707/104.1

(57) ABSTRACT

A method, computer-readable medium, and system are provided for generating a master test plan. A plurality of verification activities for monitoring adherence with project specifications is stored in a test plan database. Access to the test plan database is provided to a plurality of users. The test plan database is updated based on input from the plurality of users. From the verification activities stored from the test plan database, the test plan is generated.

### FIELD OF THE INVENTION

This invention relates generally to project planning and, more specifically, to generation of a test plan document.

### BACKGROUND OF THE INVENTION

Major projects generally involve significant planning. Furthermore, the more complex the project, the more involved the planning process becomes. Particularly in the realm of multi-million dollar contracts, customers present voluminous lists of specifications and demands for which the contractor generally must test its product, verify that the specifications are met, and report the results to the customer. Such testing, verification, and reporting generally involve a number of contractor personnel, countless meetings and tests, and a substantial paper trail to arrange and document the process.

To coordinate and manage such testing, verification, and reporting, contractors may create a master test plan (or system test plan) document. In some sectors such as aerospace, governmental entities such as the Federal Aviation Administration or a branch of the military may require such a plan. The master test plan represents a comprehensive outline of how the project will be performed, and the master test plan can be a very detailed document. For example, the master test plan lists the verification activities that are to take place to assure that specifications have been met. The master test plan breaks down the verification events into categories and/or subcategories to subdivide the project into manageable portions. The master test plan details the activities and requirements to demonstrate that specifications are met. The master test plan lists facilities needed and parties responsible for different parts of the project to track accountability throughout the process.

Not surprisingly, creation of such a document is a time-consuming process that may involve input from a number of personnel. Moreover, such a document may involve many revisions as the project is further refined, as verification activities are added or changed, or as prerequisite activities affecting other events are changed.

Unfortunately, the involvement of many people and the likelihood of changes being made can complicate creation of the master test plan. For example, if one person is put in charge of revising and updating the document, that person might be overwhelmed by having to receive and process additions and changes from many different parties. Alternatively, if multiple individuals are given access to the document, such as by storing the document on a common server, many other problems result. While a first individual accesses the document, other individuals will not be able to access the document, even if the other individuals seek to change entirely different sections than are being revised by the first individual. Alternatively, the master test plan could be corrupted by receiving multiple changes at one time. At the very least, version control would present a significant problem. The document could be subdivided into parts during its development with each part being assigned to a different group, but ultimately the person responsible for creating the document would face similar problems to the original problem in having to receive and control input from many different individuals or groups.

Put another way, FIG. 1 graphically depicts a conventional environment 100 in which a master test plan 130 is created. A customer may provide to the contractor a verification matrix database 110 listing specifications to be met by the contractor in completing the project. In the conventional environment 100, the verification matrix database 110 stands alone for contractor personnel working on the project to consult in attempting to develop subset test plans 120 for testing particular components or subsystems and a master test plan 130. The subset test plans 120 and the master test plan 130 are not linked to the verification matrix database 110 or to each other. Subsequently, tests 140 are conducted, and results of those tests 140 are entered into a test tracking database 150. Yet again, there is no link between the test plans 120 and the master test plan 130 with either the test 140 or the test tracking database 150. The lack of linkages between these bodies of information 110, 120, 130, and 150 and the tests 140 accurately suggests a great deal of effort and duplicative effort by contractor personnel in obtaining information from the verification database 110, creating documents 120 and 130, and ultimately entering information in the test tracking database 150.

Thus, there is an unmet in the art for an improved method, computer-readable medium, and system for generation of a master test plan document.

### SUMMARY OF THE INVENTION

Embodiments of the present invention provide a method, computer-readable medium, and a system for generating a master test plan. Embodiments of the present invention utilize a test plan database. Multiple users are provided access to the test plan database, or at least to portions of the master test plan database relevant to portions of a project with which they have been tasked. Using such a database allows many individuals to create, revise, and update their portions of the test plan database without the “bottleneck” of having to go through a single individual or group charged with creation of the test plan. Further, the existence of the test plan database provides for receiving data from a verification matrix database listing project requirements and specifications, being able to select portions of the test plan database to prepare subset test plans for parts of the project, and being able to pass the data to a test tracking database in which results of test will be stored.

More specifically, embodiments of the present invention provide for a plurality of verification activities for monitoring adherence with project specifications being stored in a test plan database. The project specifications are entered into the test plan database. Access to the test plan database is provided to a plurality of users. The test plan database is updated based on input from the plurality of users. From the verification activities stored from the test plan database, the test plan is generated.

According to further aspects of the present invention, the test plan can be maintained by a database manager program. Project specifications can be drawn from a verification matrix database storing the specifications, and verification activities can be linked with the project specifications. The test plan database can be secured with access given to a plurality of secured individuals.

According to other aspects of the present invention, user-selectable attributes can be assigned to the verification activities. The user-selectable attributes may be limited to a predetermined range of attributes, and the attributes can include an activity category or another type of information. The verification activities can be accessed or sorted based on the user-selectable attributes. In addition to setting or changing the attributes, users can change, revise, or remove text and non-text information regarding the verification activities. This information can include a verification activity identifier, a responsible party, a measurement desired, a measurement standard, a date for initiation, a date for conclusion, and a verification activity description. This data can be extracted to create subset test plans or passed to a test tracking database used in evaluating verification activities listed in the test plan.

### BRIEF DESCRIPTION OF THE DRAWINGS

The preferred and alternative embodiments of the present invention are described in detail below with reference to the following drawings.

FIG. 1 is a block diagram of a conventional environment in which a test plan is developed;

FIG. 2 is a block diagram of a test plan development environment according to an embodiment of the present invention;

FIG. 3 is a flowchart of a routine for developing a test plan according to an embodiment of the present invention;

FIG. 4 is screen shot of an introductory screen for a test plan database according to an embodiment of the present invention;

FIG. 5 is another screen shot of the test plan database in which a verification event is presented for possible update;

FIG. 6 is another screen shot of the verification event of FIG. 5 in which a menu selection is select another verification event;

FIG. 7 is a screen shot of a text entry screen used for creating and modifying a verification event;

FIG. 8 is another screen shot of the verification event of FIG. 5 in which a menu selection is made to identify a type of testing at involved in the verification event;

FIG. 9 is another screen shot of the verification event of FIG. 5 in which a pop-up window is activated to specify data measurements involved in the verification event;

FIG. 10 is a screen shot showing that non-textual data can be inserted into the database;

FIG. 11 is a screen shot of the test plan database tool showing a draft of a test plan being generated from the database;

FIG. 12 is a screen shot showing a table of contents of the master test plan derived from the database;

FIG. 13 is a screen shot showing a substantive portion of the master test plan derived from the database;

FIG. 14 is a screen shot showing a test summary matrix derived from the test plan database;

FIG. 15 is a screen shot showing a meeting manager for assisting in assembling relevant personnel desired for a meeting regarding an aspect of the test plan;

FIG. 16 is another screen shot of the meeting manager of FIG. 15 showing how information can be entered to track outcomes of the meeting;

FIG. 17 is a screen shot showing an agenda generator for planning a meeting; and

FIG. 18 is a screen shot of an agenda generated by the agenda generator of FIG. 17.

### DETAILED DESCRIPTION OF THE INVENTION

By way of overview, embodiments of the present invention provide for a plurality of verification activities for monitoring adherence with project specifications being stored in a master test plan database. Access to the master test plan database is provided to a plurality of users. The master test plan database is updated based on input from the plurality of users. From the verification activities stored from the master test plan database, the master test plan is generated.

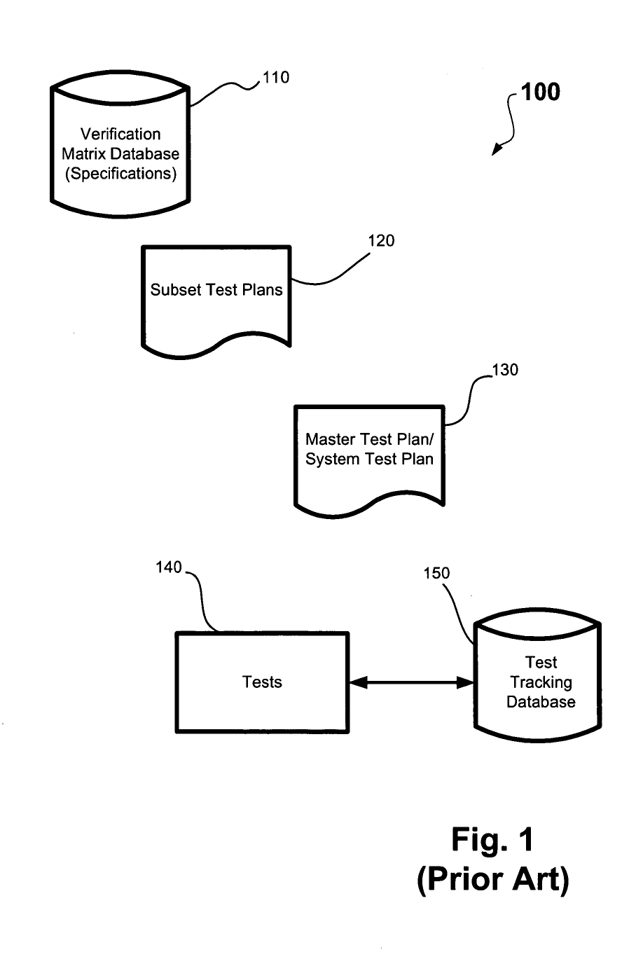

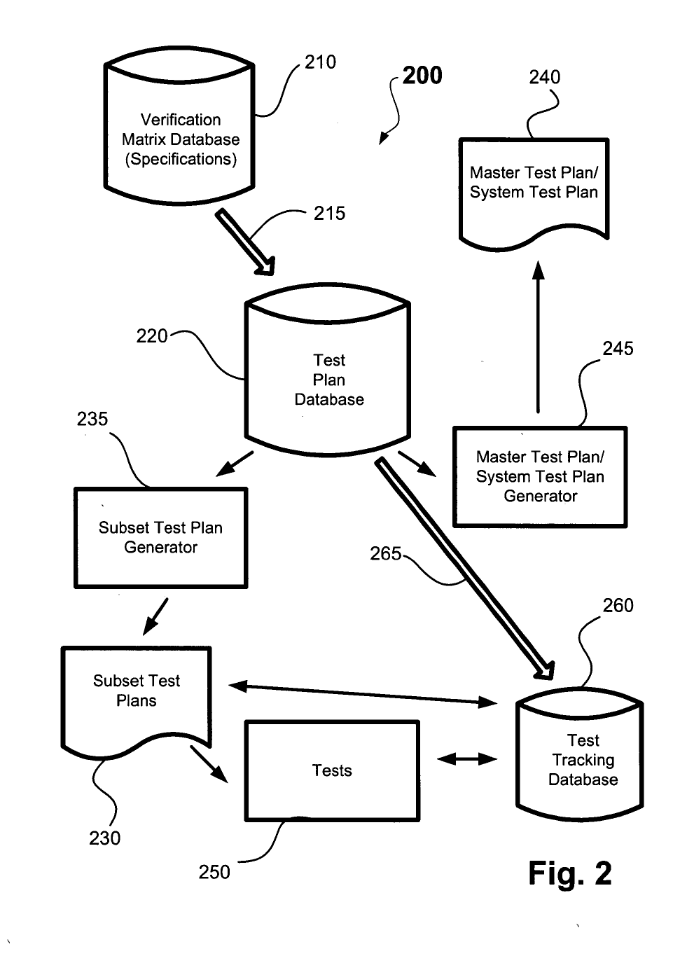

FIG. 2 shows an environment 200 in which a master test plan 240 is created according to embodiments of the present invention. As in the conventional environment 100 (FIG. 1), a customer may provide to the contractor a verification matrix database 210 listing specifications to be met by the contractor in completing the project. Unlike the conventional environment 100, however, the environment 200 employs a test plan database 220 which in one presently preferred embodiment is coupled by a communications link 215 to the verification matrix database 210. Accordingly, specifications stored in the verification matrix database 210 can be imported into the test plan database 220 to provide a foundation for the creation of the master test plan 240.

The test plan database 220 preferably is a relational database allowing for flexibility in updating and accessing data stored in the test plan database. The test plan database 220 can be managed by a commercially-available database manager program, such as Microsoft Access® or a similar product. Such database manager programs generally provide for creation of a database application for creating and managing the database, and embodiments of the present invention suitably use a database manager program to create the desired application. In addition, such database manager programs can reside on an interface and accept data from more than one user at a time, and the database manager program controls access to records to alleviate contention problems. The database manager program, under direction from the database application created, controls access to the database and parts thereof. A database administrator can authorize access for one or more secured users.

In the environment 200, the master test plan 240 is not a flat file document to be edited by one individual at a time. Multiple users can access the test plan database 220 at one time to enter, revise, and update information. When individuals developing the test plan have completed work on their portions of the test plan, a test plan generator 245 extracts test plan information from the test plan database 220 to create the test plan 240. A database manager program such as Microsoft Access® works with other programs such as Microsoft Word® or Microsoft Excel® such that data can be extracted from the database 220 and presented in a report form such as that of the test plan 240.

The test plan database 220 provides other advantages. Comparable with the test plan generator 245 generating the test plan 240 from the test plan database 220, subset test plans 230 can be extracted from the test plan database 220 using a subset test plan extractor 235. As will be appreciated by one ordinarily skilled in the art, the same facility of the database manager program that supports the test plan generator 245 also supports the subset plan generator 235. A difference between the subset plan extractor 235 and the test plan generator 245 is how the database manager is directed to extract the data. The result subset test plans 230 can then be used in the tests 250. Results of the tests 250 are entered into a test tracking database 260.

Another advantage of the test plan database 220 is that, just as data can be extracted from the verification matrix database 210 to provide the foundation for the test plan database 220, data in the test plan database 220 can be accessed by the test tracking database 260 over a communications link 265. Thus, the test plan database 220 can be used to provide a foundation for the test tracking database 260, just as in the presently preferred embodiment data can be drawn from the verification matrix database 210 and communicated to provide the foundation for the test plan database 220.

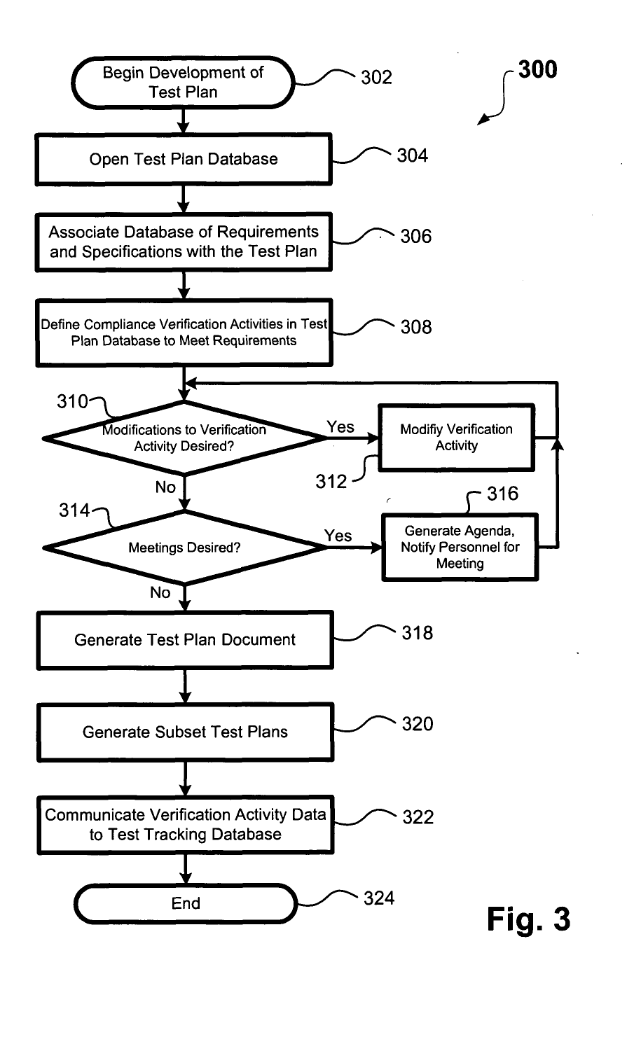

FIG. 3 is a flowchart of a routine 300 of an embodiment of the present invention. The routine 300 starts at a block 302 where test plan development begins. At a block 304, a test plan database is opened. At a block 306, a database of requirements for the project such as the verification matrix database 210 (FIG. 2) is associated with the test plan database 220. Associating the requirements can commence with copying the database of requirements to form a foundation for the test plan database, extracting a portion of the database of requirements, thereby dynamically linking the test plan database 220 with the database of requirements, or a similar process.

At a block 308, the work of building the test plan is performed. Responsible personnel define and describe the verification activities to meet the requirements. At the block 308, the processes that are to take place are textually described, thereby providing images or charts of processes to take place, assigning the processes to categories, identifying equipment and personnel needed, defining success criteria, setting deadlines, and other processes. As previously described, multiple secured individuals can work on the block 308 at the same time to facilitate efficient creation of the test plan.

According to the present invention, revising the test plan document is a flexible process. At a decision block 310, it is determined if revisions to the test plan are desired. According to an embodiment of the present invention, users can make the determination to revise their verification activities within the test plan at any time. If it is determined at the decision block 310 that modification to a verification activity is desired, at a block 312 a responsible person or responsible persons modify the verification activity. It will be appreciated that no one involved in the project need wait for others to complete work on their own verification activities to revise their own verification activities. Use of the test plan database 220 (FIG. 2) allows for a number of users to work in parallel in creating and revising their own verification activities within the test plan.

Advantageously, use of the test plan database provides support for holding meetings to discuss and develop verification activities making up the test plan. At a decision block 314, it is determined if a meeting is desired to review verification activities. If so, at a block 316 the names of persons involved in one or more verification activities are extracted from the test plan database 220 (FIG. 2) to create a list of persons who should be notified of the meeting. Also, content describing the verification activities can be extracted to form the basis for a meeting agenda. Once the meeting has been held, it can be determined at the decision block 310 if modifications to the test plan are desired and it can be determined at the decision block 314 if more meetings should be planned.

At a block 318 a test plan document is generated. It will be appreciated that creation, revision, and discussions of verification activities all have been made without generating monolithic drafts of test plans (which would have to be circulated and returned to a test plan coordinator for revisions). At a block 320, as desired, subset test plans can be generated from the test plan database without having to recreate or re-key the information. Similarly, at a block 322, the verification activity data previously created and revised can be imported into the test tracking database from the test plan database, further saving time and costs. The routine 300 ends at a block 324.

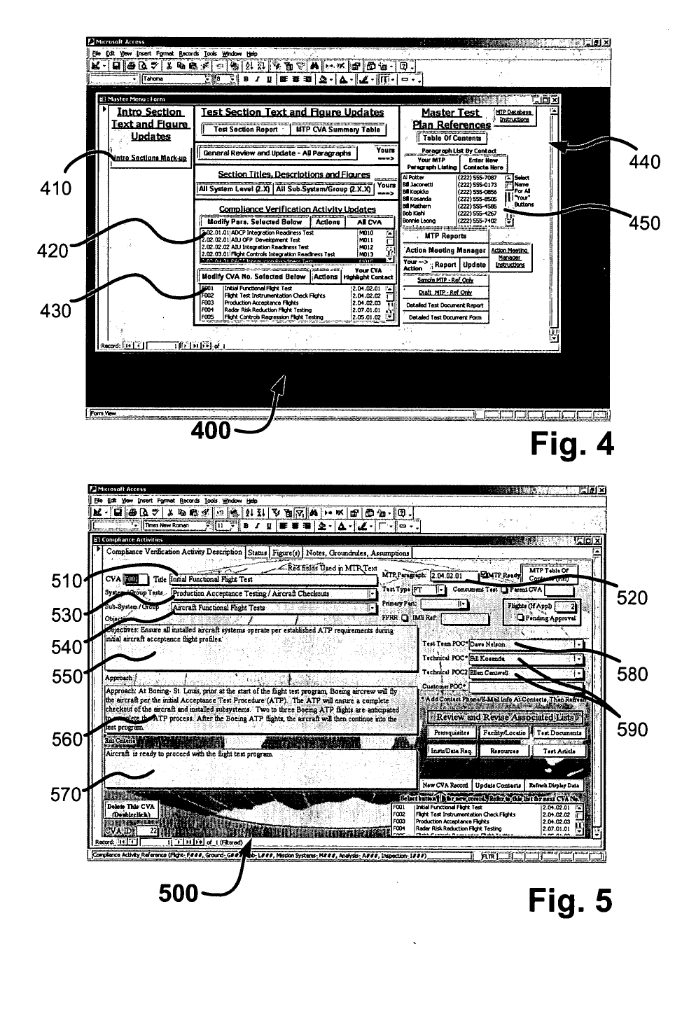

To further illustrate operation of embodiments of the present invention, FIGS. 4-18 present a series of screen shots of a program according to an embodiment of the present invention. The program shown runs under Microsoft Windows® and uses the Microsoft Access® Database Manager. It will be appreciated, however, that programs can be written to run under other operating systems according to embodiments of the present invention. Further, programs can be written to perform their own database management without using a database manager program.

FIG. 4 is a screen shot of an initial screen 400 for a particular test plan database. The screen 400 is an introductory screen for a test plan database. The screen 400 presents a number of choices to a user for updating the test plan database. The user can choose an “intro sections markup” button 410 to edit the introductory portions of a test plan 240 (FIG. 2) which will be generated from the test plan database. The user can choose a paragraph from among a compliance verification activity paragraph list 420 to revise or update. The user also can choose the same compliance verification activity to access from a compliance verification activity list 430. A program according to an embodiment of the present invention allows for verification activities to be created or, advantageously, the list of compliance verification activities may be extracted from a compliance verification activity matrix 210 (FIG. 2) into the test plan database 240. The screen 400 also presents means to access other aspects of the program. A master test plan reference menu 440 allows access to a report generator, meeting manager, and other functions. A beneficial function is a contact list 450 from which personnel attached with the project can be readily associated with verification activities and other tasks.

FIG. 5 shows a verification activity editing screen 500. The screen 500 includes a verification activity title 510 and a test plan section designation 520 to indicate where the verification activity is situated within the test plan. The screen features a menu-selectable verification activity category 530 and an activity sub-category 540 for properly placing the verification event in the hierarchy of the test plan. The screen 500 also includes three text fields 550, 560, and 570. The first text field 550 is an objective field in which the goal of the particular verification activity is described. The second text field 560 is an approach field 560 in which the process by which the verification activity to be conducted is described. The third text field 570 is an exit criteria field in which the result which will satisfy the requirements for the verification activity are listed. The screen 500 also lists involved personnel. A test team point-of-contact field 580 lists a person primarily responsible for the verification activity. Technical point-of-contact fields 590 list individuals involved in the technical aspects of completing the verification activity. It will be appreciated that the persons listed in these fields 580 and 590 might be among secured users of the system as previously described who can access the screen to revise the verification activity at issue.

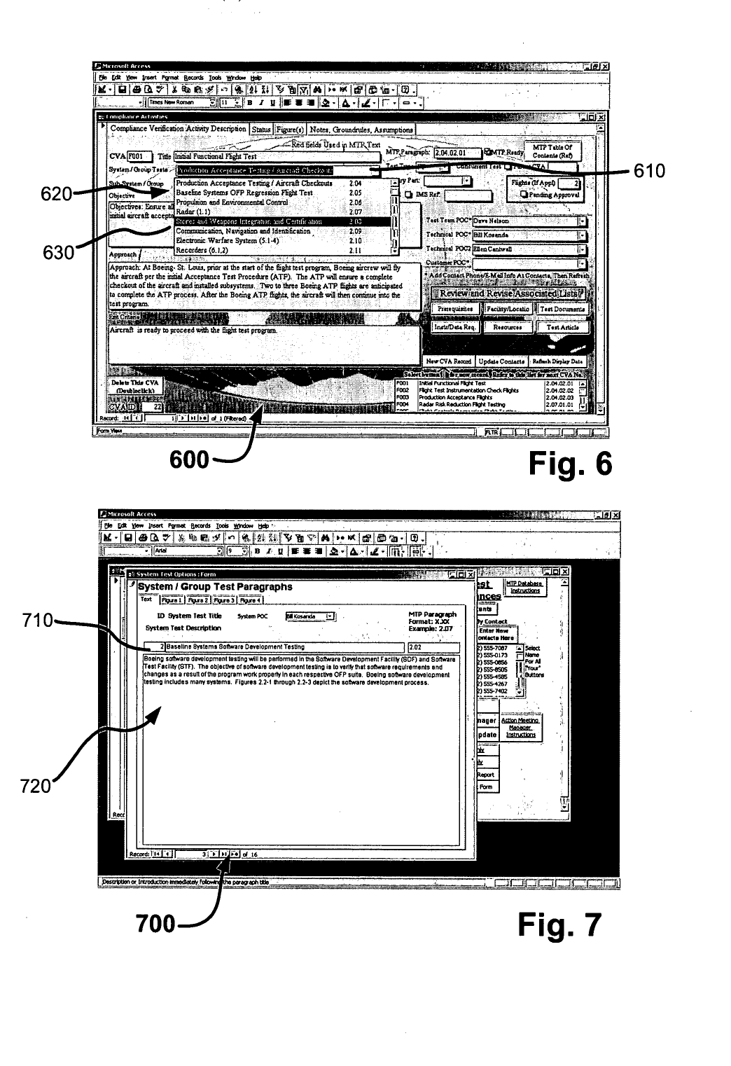

FIG. 6 is another view of the verification activity editing screen 600 on which the user has engaged a menu button 610 for the verification activity category 530 (FIG. 5). A menu 620 lists the verification activities that can be selected, and a reverse-video bar 630 highlights the user's choice.

FIG. 7 is a text entry screen 700. Having selected a verification activity identified in a verification activity category field 710, the user can enter or revise text in a text entry window 720 describing the activity. This text will later appear in the verification activity editing screen 500 (FIG. 5) for the verification activity at issue.

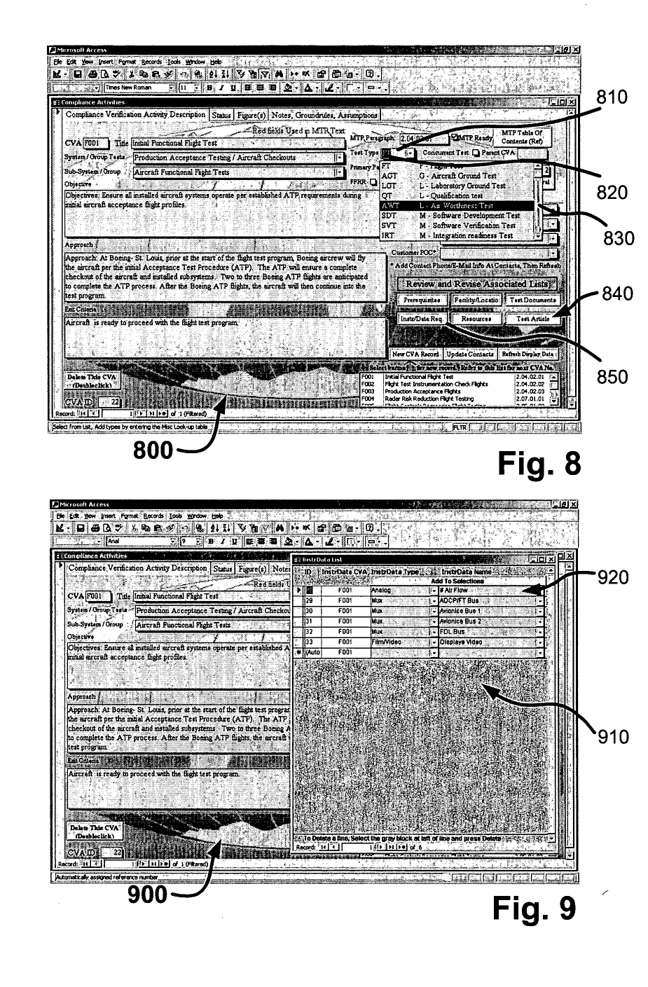

FIG. 8 is another screen 800 shot of the verification activity editing screen 500 (FIG. 5). From a test type menu 810, a user can select a test type 820 associated with the verification activity. A drop-down menu 830 lists available test choices. The screen 800 also provides access to other information associated with the verification activity. A review associated lists section 840 of the screen features a number of buttons allowing access to other information about the verification activity. For example, an instrument data button 850 allows access to the types of data that can be measured in carrying out the verification activity.

FIG. 9 is a screen 900 showing an effect of selecting the instrument data button 850 of screen 800 (FIG. 8). Selecting the button 850 activates a pop-up window 910 that lists the types of data involved in completing the verification activity. From this window 910, types of data can be specified that will be logged and used to evaluate the success of the verification activity.

FIG. 10 shows flexibility of the test plan database 220 (FIG. 2) to accommodate data in other-than-text form for building the test plan 240 (FIG. 2). More specifically, a screen 1000 shows a photograph 1010 being inserted to elaborate on the nature of the verification activity. The non-text data could be a photograph 1010, a chart, a diagram, or any other form of non-text data. Such non-text data may be included with the objective field 550 (FIG. 5) to describe the goal of the verification activity, the approach field 560 to describe the process by which the verification activity is to be conducted, or the exit criteria field 570 to illustrate what will constitute a successful result. Such non-text data also suitably is used with other fields. Thus, the test plan database 220 is flexible enough to accommodate many forms of data.

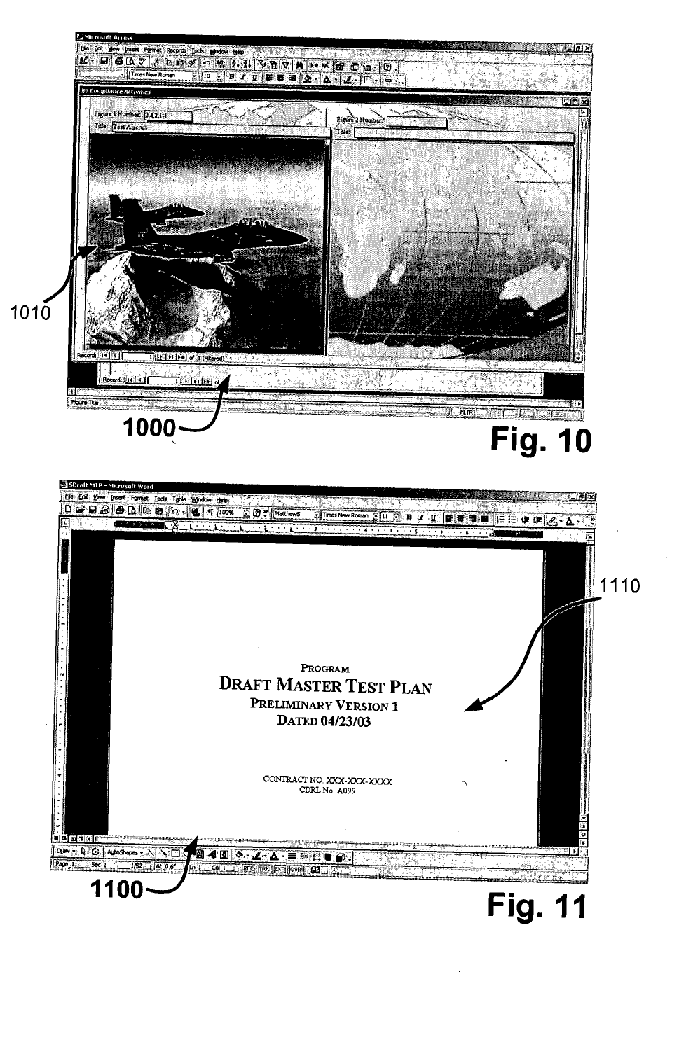

FIG. 11 shows a screen 1100 of a first page, such as a title page, of a master test plan 1110 which can be generated from the test plan database 220 (FIG. 2) according to an embodiment of the present invention. The screens 400-1000 previously described provide for entry and editing of verification activity information; once the information has been entered and a user has requested the test plan, a test plan generator 245 produces the report from the database automatically. As previously described, if a database manager such as Microsoft Access® is used to manage the database, the report can be generated in a Microsoft Word® format as shown for document creation.

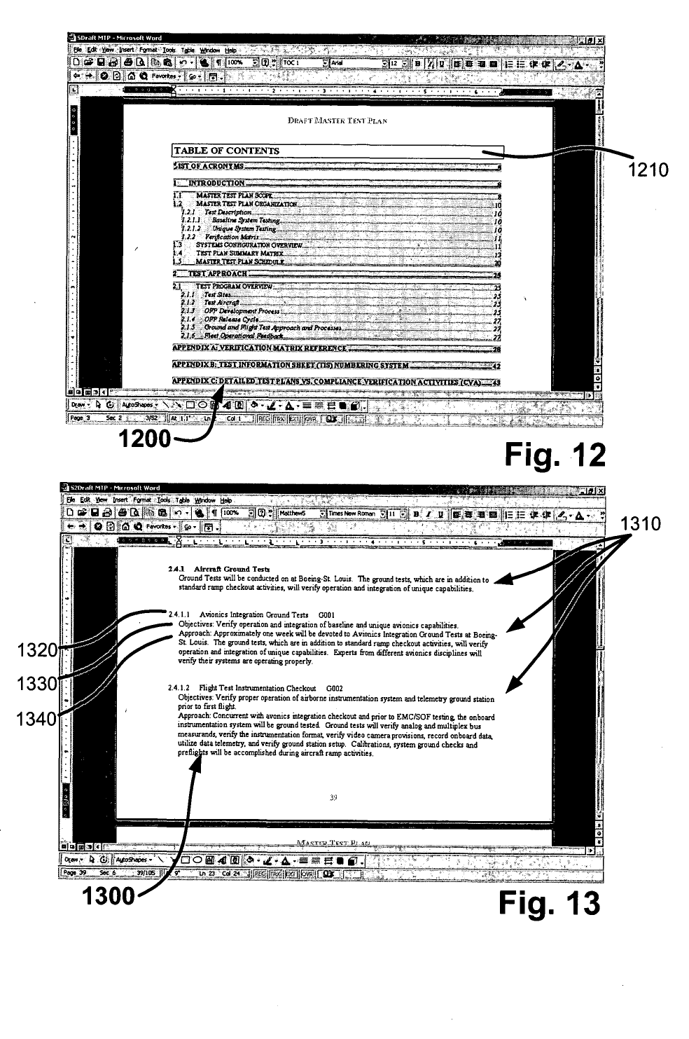

FIG. 12 shows a table of contents 1210 that can be generated from the test plan database 220 (FIG. 2). The categories 530 and subcategories 540 (FIG. 5) suitably are used as headings in the table of contents 1210 as well as in the body of the test plan, with the sections being organized according to a test plan section designation 520. Thus, one presently preferred embodiment of the present invention can generate the table of contents 1210 automatically.

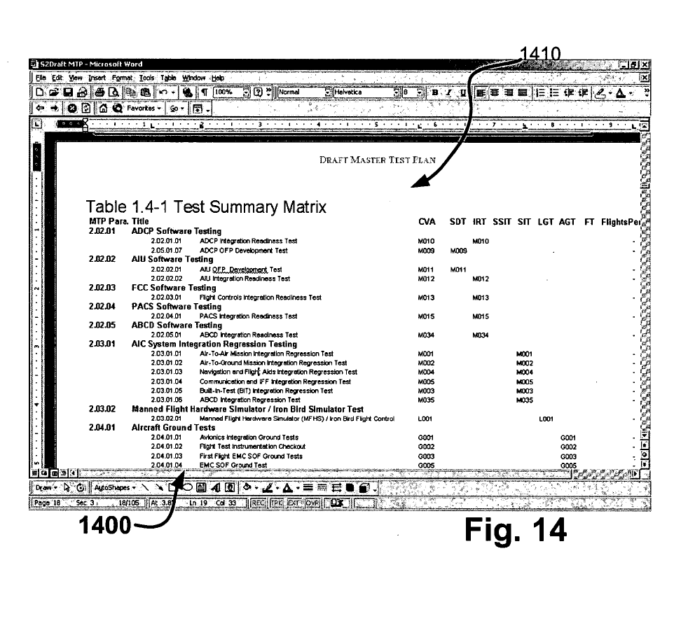

FIG. 13 shows a screen 1300 showing sections 1310 of the master test plan. The sections 1310 are listed by test plan section 1320 and present the objective 1330 and approach 1340 (previously entered into the verification activity editing screen 500 (FIG. 5)). Other information could also be selected at the user's direction depending on the type of report desired. For example, as part of the master test plan or extracted by itself, FIG. 14 shows a screen shot 1400 that is a test summary matrix 1410 which summarizes specific activities associated with the verification activities.

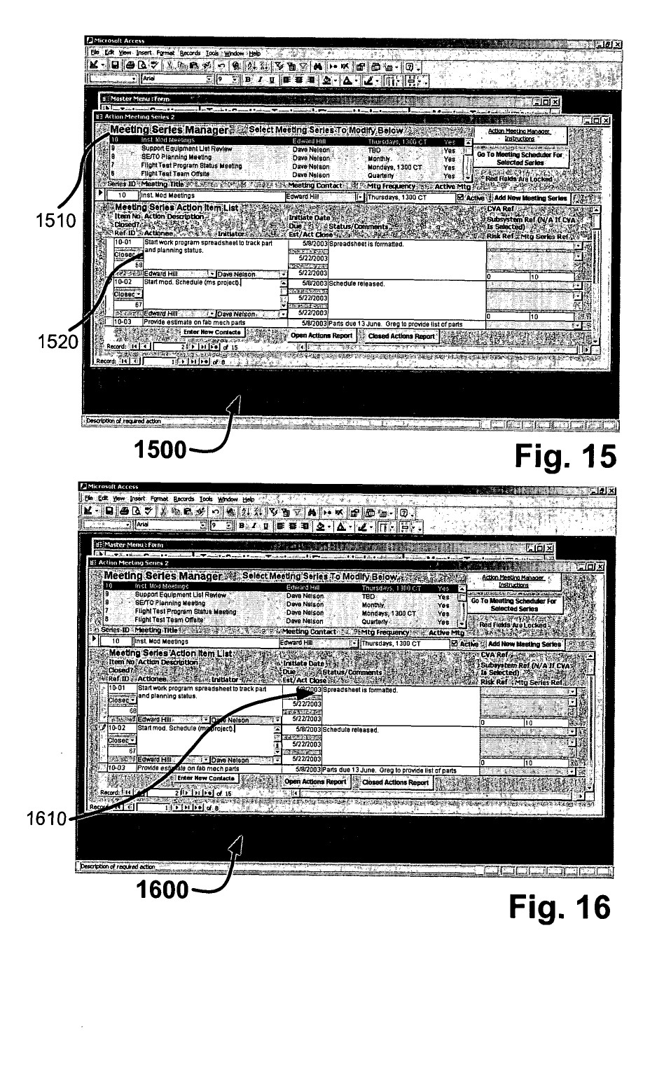

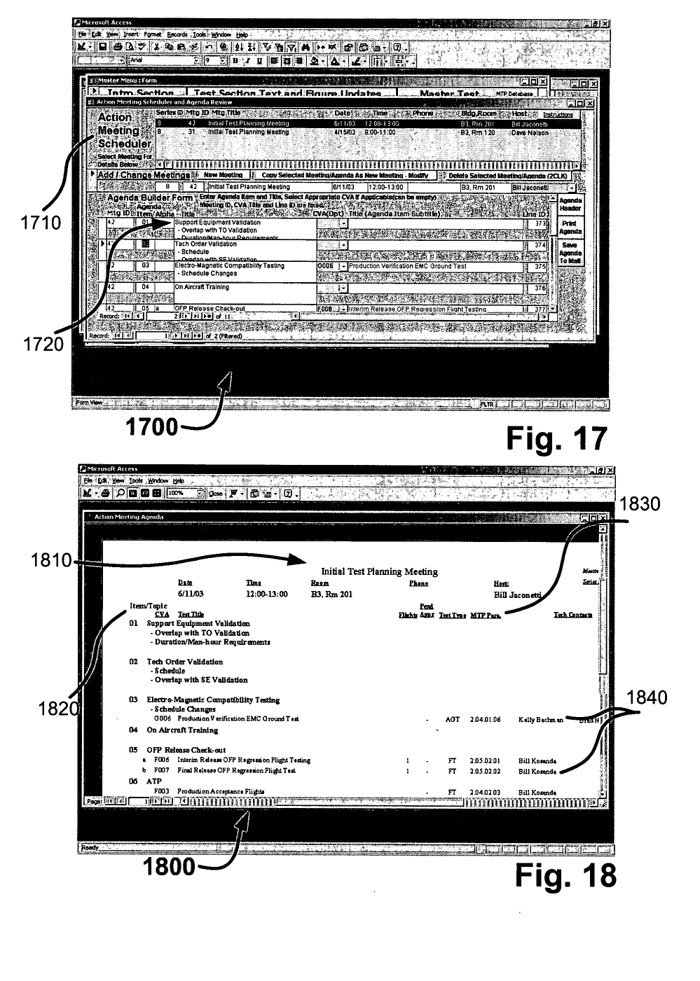

Embodiments of the present invention also offer other advantages, such as meeting planning support. FIG. 15 shows a screen 1500 of a meeting manager 1510. The meeting manager 1510 allows for action items 1520 to be identified about which a meeting might be held to refine the test plan. FIG. 16 shows another screen 1600 from the meeting manager 1510 (FIG. 15) showing that outcomes of the meeting can be entered into the test plan database for later use in refining the test plan. Similarly, FIG. 17 shows a screen 1700 from a meeting scheduler 1710 that is used to create agendas for a meeting concerning an activity verification event. Agenda item fields 1720 allow for elements of verification activities to be selected for inclusion on a meeting agenda. FIG. 18 shows a screen 1800 showing the meeting agenda 1810. The agenda 1810 features a range of information including topics 1820 for discussion, cross-references 1830 to the test plan and, persons responsible 1840 for the items. The agenda 1810 thus can be extracted from the test plan database to expedite setting up a meeting.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for generating a test plan document for governing adherence with project specifications, the method comprising:
storing in a test plan database a plurality of verification activities for monitoring adherence with project specifications;
entering references to the project specifications into the test plan database;
providing access to the test plan database to a plurality of users;
updating the test plan database based on input from the plurality of users; and
generating a test plan listing at least one of the verification activities stored from the test plan database.

2. The method of claim 1, wherein the test plan database is maintained by a database manager program.

3. The method of claim 1, wherein the project specifications are entered in to the test plan database by coupling a verification matrix database to the test plan database.

4. The method of claim 1, further comprising associating the verification activities with at least one of the project specifications.

5. The method of claim 1, wherein access to at least one secured verification activity is provided to a secured user.

6. The method of claim 5, wherein an administrator assigns the access of the secured user to the at least one secured verification activity.

7. The method of claim 1, further comprising providing a user-selectable attribute assignable to the verification activities.

8. The method of claim 7, further comprising providing a predetermined range of values for the user-selectable attribute.

9. The method of claim 7, wherein the verification activities are accessible by specifying a desired value of the user-selectable attribute.

10. The method of claim 7, wherein the verification activities are sortable by the user-selectable attribute.

11. The method of claim 7, wherein the user-selectable attribute is a verification activity category.

12. The method of claim 1, wherein the input from the plurality of users includes one of changed text, revised text, removed text, inserted non-text media, revised non-text media, and removed non-text media.

13. The method of claim 1, wherein the verification activities include at least one of verification activity identifier, a responsible party, a measurement desired, a measurement standard, a date for initiation, a date for conclusion, and a verification activity description.

14. The method of claim 1, further comprising extracting subset test plans describing less than all of the verification activities.

15. The method of claim 1, further comprising communicating the verification activities to a test tracking database.

16. A method for generating a test plan document for governing adherence with project specifications, the method comprising:
storing in a test plan database a plurality of verification activities for monitoring adherence with project specifications;
entering references to the project specifications into the test plan database;
associating each of the verification activities with at least one of the project specifications;
providing access to the test plan database to a plurality of users;
providing a user-selectable attribute assignable to the verification activities;
receiving input from at least one of the plurality of users, the input being associated with at least one of the verification activities;
updating the test plan database based on the input; and
generating a test plan listing at least one of the verification activities stored from the test plan database.

17. The method of claim 16, wherein the project specifications are entered in to the test plan database by coupling a verification matrix database to the test plan database.

18. The method of claim 16, wherein access to at least one secured verification activity is provided to a secured user.

19. The method of claim 18, wherein an administrator assigns the access of the secured user to the at least one secured verification activity.

20. The method of claim 16, further comprising providing a predetermined range of values for the user-selectable attribute.

21. The method of claim 16, wherein the verification activities are accessible by specifying a desired value of the user-selectable attribute.

22. The method of claim 16, wherein the verification activities are sortable by the user-selectable attribute.

23. The method of claim 16, wherein the user-selectable attribute is a verification activity category.

24. The method of claim 16, wherein the input from the plurality of users includes one of changed text, revised text, removed text, inserted non-text media, revised non-text media, and removed non-text media.

25. The method of claim 16, wherein the verification activities include at least one of verification activity identifier, a responsible party, a measurement desired, a measurement standard, a date for initiation, a date for conclusion, and a verification activity description.

26. The method of claim 16, further comprising extracting subset test plans describing less than all of the verification activities.

27. The method of claim 16, further comprising communicating the verification activities to a test tracking database.

28. A computer-readable medium for generating a test plan document for governing adherence with project specifications, the computer-readable medium comprising:
first computer program code means for providing a test plan database storing a plurality of verification activities for monitoring adherence with project specifications;
second computer program code means for entering references to the project specifications into the test plan database;
third computer program code means for providing access to the test plan database to a plurality of users;
fourth computer program code means for updating the test plan database based on input from the plurality of users; and
fifth computer program code means for generating a test plan listing at least one of the verification activities stored from the test plan database.

29. The computer-readable medium of claim 28, wherein the test plan database is maintained by a database manager program.

30. The computer-readable medium of claim 28, wherein the project specifications are entered in to the test plan database by coupling a verification matrix database to the test plan database.

31. The computer-readable medium of claim 28, further comprising sixth computer program code means for associating the verification activities with at least one of the project specifications.

32. The computer-readable medium of claim 28, wherein access to at least one secured verification activity is provided to a secured user.

33. The computer-readable medium of claim 32, wherein an administrator assigns the access of the secured user to the at least one secured verification activity.

34. The computer-readable medium of claim 28, further comprising seventh computer program code means for providing a user-selectable attribute assignable to the verification activities.

35. The computer-readable medium of claim 34, further comprising eighth computer program code means for providing a predetermined range of values for the user-selectable attribute.

36. The computer-readable medium of claim 34, wherein the verification activities are accessible by specifying a desired value of the user-selectable attribute.

37. The computer-readable medium of claim 34, wherein the verification activities are sortable by the user-selectable attribute.

38. The computer-readable medium of claim 34, wherein the user-selectable attribute is a verification activity category.

39. The computer-readable medium of claim 28, wherein the input from the plurality of users includes one of changed text, revised text, removed text, inserted non-text media, revised non-text media, and removed non-text media.

40. The computer-readable medium of claim 28, wherein the verification activities include at least one of verification activity identifier, a responsible party, a measurement desired, a measurement standard, a date for initiation, a date for conclusion, and a verification activity description.

41. The computer-readable medium of claim 28, further comprising ninth computer program code means for extracting subset test plans describing less than all of the verification activities.

42. The computer-readable medium of claim 28, further comprising tenth computer program code means for communicating the verification activities to a test tracking database.

43. A system for generating a test plan document for governing adherence with project specifications, the system comprising:
a test plan database configured to store a plurality of verification activities for monitoring adherence with project specifications;
a specification entry system configured to enter references to the project specifications into the test plan database;
at least one data entry device configured to allow access to the test plan database by a plurality of users; and
a test plan generator configured to generate a test plan listing at least one of the verification activities stored from the test plan database.

44. The system of claim 43, further comprising a database manager program configured to maintain the test plan database.

45. The system of claim 43, further comprising a verification matrix database configured to communicate the project specifications from a verification matrix database to the test plan database.

46. The system of claim 43, further comprising a verification activity associator configured to associate the verification activities with at least one of the project specifications.

47. The system of claim 43, wherein access to at least one secured verification activity is provided to a secured user.

48. The system of claim 47, wherein an administrator assigns the access of the secured user to the at least one secured verification activity.

49. The system of claim 43, further comprising an attribute selector configured to provide a user-selectable attribute assignable to the verification activities.

50. The system of claim 49, wherein the attribute selector provides a predetermined range of values for the user-selectable attribute.

51. The system of claim 49, wherein the verification activities are accessible by specifying a desired value of the user-selectable attribute.

52. The system of claim 49, wherein the verification activities are sortable by the user-selectable attribute.

53. The system of claim 49, wherein the user-selectable attribute is a verification activity category.

54. The system of claim 43, wherein the input from the plurality of users includes one of changed text, revised text, removed text, inserted non-text media, revised non-text media, and removed non-text media.

55. The system of claim 43, wherein the verification activities include at least one of verification activity identifier, a responsible party, a measurement desired, a measurement standard, a date for initiation, a date for conclusion, and a verification activity description.

56. The system of claim 43, further comprising a test plan extractor configured to extract subset test plans describing less than all of the verification activities.

57. The system of claim 43, further comprising a test tracking database link configured to the verification activities to a test tracking database.
